(19) United States
(12) Patent Application Publication
(10) Pub. No.: US 2008/0001380 A1
(43) Pub. Date: Jan. 3, 2008

(54) VEHICLE, IN PARTICULAR AN ALL-WHEEL DRIVE VEHICLE, WITH A FIRST STEERED VEHICLE AXLE AND A SECOND STEERED VEHICLE AXLE

(75) Inventors: Ulrich MAIR, Friedrichshafen (DE); Stefan Wallner, Friedrichshafen (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 11/767,083

(22) Filed: Jun. 22, 2007

(30) Foreign Application Priority Data
Jun. 29, 2006 (DE) 10 2006 030 143.9

(51) Int. Cl. B62D 5/26

(52) U.S. Cl. 280/137.5

(57) ABSTRACT

An all-wheel drive vehicle with two steered vehicle axles. Each having a main steering cylinder with piston rods actively connected with the wheels. The main steering cylinders each have first and second chambers (30, 31) delimited by at least one piston element (34, 35) which moves longitudinally in the cylinder and is connected to the piston rod (28), such that adjusting pressure in the cylinder with an electric control unit, biases the piston elements and the piston rods to achieve specified wheel steering angles. Furthermore, a third chamber (32), which can be pressurized, is provided between a first and a second piston element (34, 35) of a main steering cylinder (26), which respectively delimit the first and second chamber (30, 31). The piston rods are sectioned, such that a first section is connected to the first piston element and a second section is connected to the second piston element.

This application claims priority from German Application Serial No. 10 2006 030 143.9 filed Jun. 29, 2006.

### FIELD OF THE INVENTION

The invention concerns a vehicle, in particular an all-wheel drive vehicle, with a first steered vehicle axle and a second steered vehicle axle.

### BACKGROUND OF THE INVENTION

In practice, vehicles and in particular all-wheel drive vehicles are known, for example so-termed telescopic loaders or telemanipulators, which are preferably used as construction vehicles. Because there is often only restricted room available on building sites, such vehicles have to be able to maneuver within very small spaces.

Accordingly, it is sought to make such vehicles with as small a turning radius as possible. For this purpose the vehicles are fitted with two vehicle axles that can both be steered, for example by way of an axle-pivot or a pivoted bogie steering system, but large wheel steering angles are needed in order to achieve the required maneuverability.

Unfortunately, the steering angle error in construction vehicles made with a short: wheelbase increases with increasing wheel steering angle. However, an increase of the steering angle error is undesired because, if the wheels are affected by steering angle error, sliding movements occur, which result in high tire wear. Particularly in the case of construction vehicles, this is a great disadvantage because tire replacement entails very high costs.

Accordingly, the purpose of the present invention is to provide a vehicle of the type described above, which is characterized by a very small turning radius and, at the same time, by lower tire wear.

### SUMMARY OF THE INVENTION

A vehicle, in particular an all-wheel drive vehicle, with a first steered vehicle axle and a second steered vehicle axle is proposed. The axles each comprise a main steering cylinder, whose piston rods are in active connection with wheels of the vehicle axles; the main steering cylinders, being formed in each case with a first chamber, and a second chamber, which are delimited by at least one piston element arranged to be able to move longitudinally in a cylinder device and connected to one of the piston rods, which can be acted upon by a control pressure that can be adjusted by an electric control unit to produce the required wheel steering lock angle. According to the invention, in each case, between a piston element that delimits the first chamber and one that delimits the second chamber of a main steering cylinder, a third chamber is formed that can be acted upon by control pressure. The piston rods are made in more than one section and, in each case, a first section being connected to a first piston element that delimits the first chamber and a second section is connected to a second piston element that delimits the second chamber of a main steering cylinder.

In a vehicle designed, according to the invention, it is advantageously possible to move the first piston element, relative to the second piston element with the first and second sections of the piston rod, respectively, attached thereto so that, in the area of the two wheels on a vehicle axle, a different wheel steering angle can be set. By virtue of this ability to adjust, the wheel steering angles of the wheels of a vehicle axle independently of one another, by way of the control pressure, a steering angle error that occurs, for example while driving around a turn, can be compensated in an advantageous manner.

Furthermore, in a vehicle with the inventive design including two vehicle axles made as described above, the steering angles of all the wheels can be made in such a manner that the extensions of the center lines of the axle steering knuckles meet at least approximately at a point in the middle of the vehicle and a steering angle error is minimal. With such control of the wheel steering angles, if it is possible to turn the wheels of an all-wheel drive vehicle arranged on one side of the vehicle in the opposite direction of the wheels on the other side of the vehicle, then the vehicle will advantageously spin around the vehicle mid-point. A vehicle made in this way has a very small turning circle, which is particularly advantageous for construction vehicles.

Construction vehicles known from current practice are made, among other things, with superstructures, such as cranes, rotating turrets or the like, which are, in each case, equipped in the area between the superstructure and the supporting structures of the vehicle with mechanisms for rotating the superstructures relative to the supporting structures. In a vehicle with the inventive system design, no such device for rotating a vehicle superstructure, relative to its supporting structure, is needed since the superstructure can be rotated by turning the vehicle as a whole relative to its surroundings, even within a small maneuvering area. Consequently, a construction vehicle, built in accordance with the invention, can be produced considerably more cheaply.

In a further development of the vehicle, according to the invention, a third chamber of the main steering cylinder can be pressurized with control pressure by way of a switching control valve device preferably made as a 3/3 magnetic control valve. This constitutes a particularly simple, compact and inexpensive design in which, preferably other control valve devices associated with the first chamber and the second chamber of the main steering cylinder can be used together with the control valve device associated with the third chamber to set or adjust the wheel steering angles of the individual wheels.

Particularly accurate adjustment of the steering angle of the wheels can be achieved by providing sensors that determine the steering angles of the wheels, which are in active connection with an electric control device for adjusting the control pressure for the third chamber of the main steering cylinder, by which the control valve device associated with the third chamber is actuated, such that the electric control device receives feedback signals from the sensors concerning the realization of specified values and can, if necessary, adapt the wheel steering angles with reference to differences between the actual and intended values thereof.

In addition, the electric control device can be in active connection with an electric control unit that feeds control pressure to the first and second chambers of the main steering cylinder, by way of the valve devices associated with the first and second chambers are actuated to be able to match the control pressures in the various chambers of the main steering cylinder to one another to an extent that minimizes steering angle errors. Thus, in the area of the electric control device and/or in the area of the control unit, it is preferably possible to advantageously verify whether the desired wheel positions have been reached.

In a further embodiment of the inventive vehicle, the sensors that determine the wheel steering angles are in direct active connection with the electric control unit. In this case, both of the control valve devices, associated with the first and second chambers, and the control valve devices, associated with the third chambers, can be actuated by the control unit since the function of the electric control device is implemented in the control unit. In this connection, at the discretion of those with knowledge of the field, the chambers of the main steering cylinder can be controlled, in each case, either by both the electric control unit and the electric control device or by the electric control unit alone, depending on the respective application, and with regard to the structural space available and the line lengths required for the connection of the various elements. It can also be provided that each vehicle axle is associated with an electric control device of its own or that both vehicle axles are subject to the control of a common electric control device.

To establish the steering angles of the wheels, the sensors can also be associated directly with the main steering cylinders so that the steering angles are determined from the positions of the piston elements.

If both the first section of the piston rods and the second section of one piston rod are, in turn, made in two parts and articulated with respect to one another by way of a hinge joint, mechanical stresses, resulting from movements of the vehicle axle elements that occur while driving round a curve, can be reduced or completely avoided in a simple manner, which advantageously increases the life of the vehicle axles.

### BRIEF DESCRIPTION OF THE DRAWINGS

The invention will now be described, by way of example, with reference to the accompanying drawings. For the sake of clarity in the description of the various example embodiments, the same indices are used for components having the same structure and function. The drawings show:

FIG. 1 is a simplified schematic diagram of a first embodiment of a vehicle according to the invention;

FIG. 2 is a simplified schematic diagram of a second embodiment of a vehicle according to the invention, and

FIG. 3 is another schematic representation of a vehicle according to the invention.

### DETAILED DESCRIPTION OF THE INVENTION

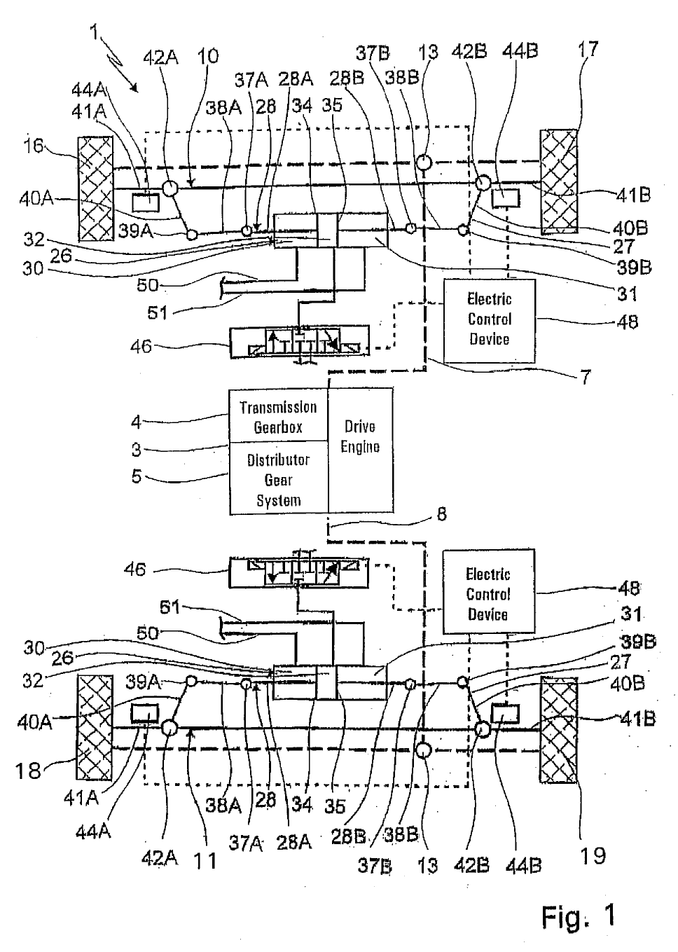

FIG. 1 shows a schematic representation of a vehicle 1, in the present case, made as an all-wheel drive vehicle. The vehicle 1 has a drive engine 3 which produces a drive torque. In a known manner, the drive torque is transmitted by a gearbox 4 and a distributor gear system 5 to two drive shafts, represented in the Figure by heavy broken lines, of which a first drive shaft 7 is associated with a first vehicle axle 10 and a second drive shaft 8 is associated with a second transverse vehicle axle (not shown) which is structurally the same as the first vehicle axle 10.

By way of a first differential unit 13, associated with the first vehicle axle 10, and a second differential unit, associated with the second transverse vehicle axle, the drive torque is transmitted to wheels 16, 17 connected to the respective vehicle axle 10 and the second vehicle axle (not shown).

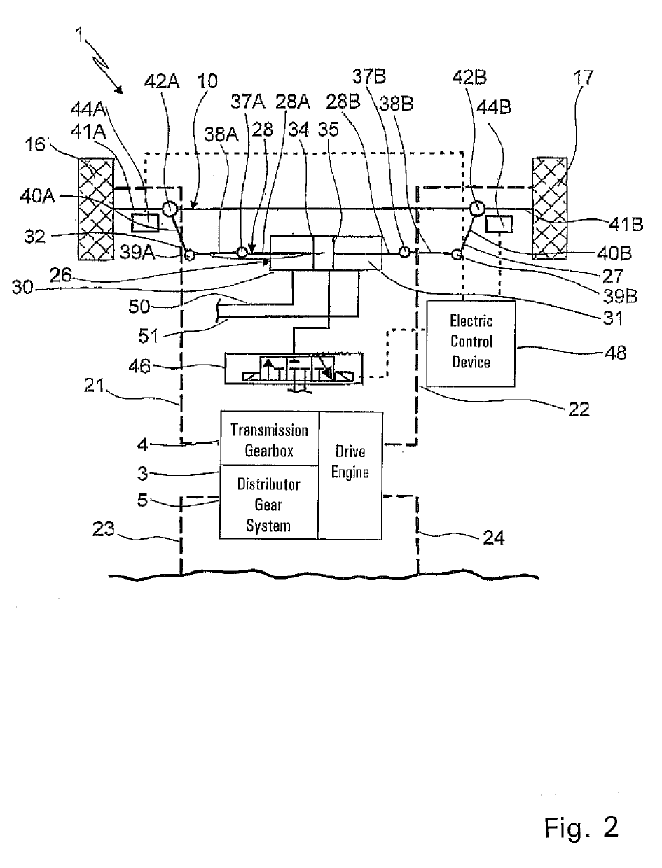

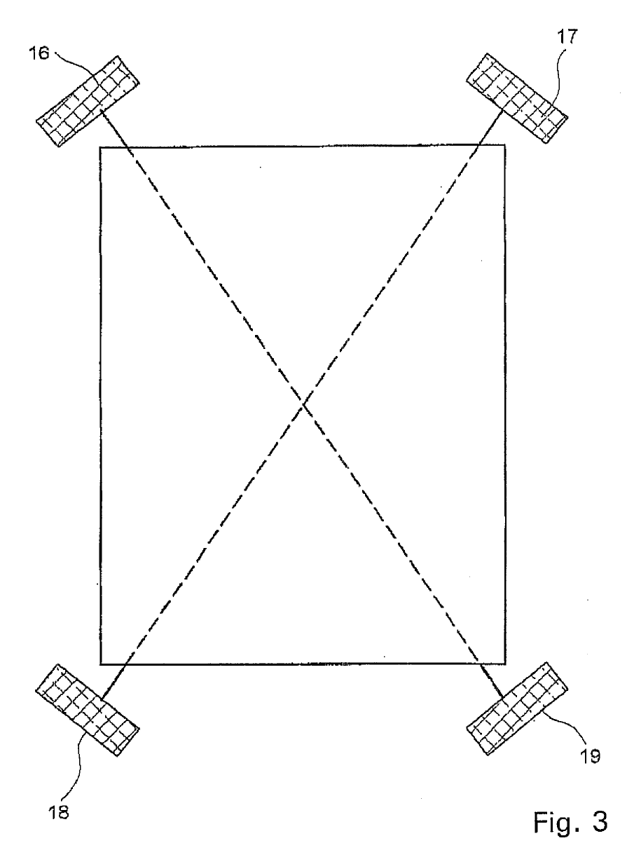

FIG. 2 illustrates the schematic diagram of a second embodiment of the vehicle 1 in which, from the distributor gear system 5, two drive shafts 21, 22 extend to the wheels 16, 17 connected to the first vehicle axle 10, such that the first drive shaft 21 drives the wheel 16 and the second drive shaft 22 drives the wheel 17. In a manner equivalent to the drive shafts 21 and 22 associated with the wheels 16 and 17, two more drive shafts 23, 24 extend from the distributor gear system 5 to the wheels associated with the second vehicle axle and shown in FIG. 3, the third drive shaft 23 driving a wheel 18 and the fourth drive shaft 24 driving a wheel 19.

In the vehicles 1, according to FIGS. 1 and 2, both the first vehicle axle 10 and the second vehicle axle can be steered. Since the steering mechanisms of both axles have the same structure, in what follows only a steering mechanism 27, associated with the first transverse vehicle axle 10, will be described.

The steering mechanism 27 of the first vehicle axle 10, shown in FIGS. 1 and 2, in the present case, is made with a main steering cylinder 26 formed as a synchronous cylinder with a piston rod 28, the main steering cylinder 26 being orientated in the transverse direction of the vehicle parallel to the vehicle axle 10 which, in a known way, extends between the wheels 16, 17. Besides a first chamber 30, used in conventional steering systems, and a second chamber 31, the main steering cylinder also has a third chamber 32 located in the transverse direction of the vehicle between the first chamber 30 and the second chamber 31.

The piston rod 28 is made in two parts, relative to the middle of the vehicle, and the parts, associated with each side of the vehicle, are each also made in two sections and consist of a first section 28A of the piston rod 28 and a track rod 38A on one side of the vehicle, and a second section 28B of the piston rod 28 and a track rod 38B on the other side of the vehicle.

The chambers 30, 31 and 32 are separated from one another by a first piston element 34, which is arranged between the first chamber 30 and the third chamber 32 and is connected to the first section 28A of the piston rod 28, and a second piston element 35, which is arranged between the second chamber 31 and the third chamber 32 and is connected to the second section 28B of the piston rod 28. Thus, the first section 28A and the second section 28B of the piston rod 28 can move relative to one another in the transverse direction of the vehicle, depending on the volume of fluid in the third chamber 32 of the main steering cylinder 26.

The respective ends of the first section 28A and the second section 28B of the piston rod 28, facing away from the main steering cylinder 26, are articulated, in each case, by piston rod links 37A, 378 formed as a ball joint to the respective track rods 38A and 38B. In turn, at their ends, facing away from the piston rod 28, the track rods 38A and 38B are, in each case, articulated by respective track rod links 39A, 39B, also made as ball joints, to wheel supports 40A, 40B. The wheel supports 40A, 40B are fixed on wheel hubs 41A, 41B of the wheels 16 and 17, which are, in turn, made so that together with the wheels 16 and 17, they can swivel relative to the vehicle axle 10 about steering rotation axes 42A, 42B.

In a known way, the first chamber 30 and the second chamber 31 of the main steering cylinder 26 are connected, via pressure lines 50, 51 to a fluid circuit by way of which a fluid can flow either into the respective chamber 30 or 31 or out of the respective chamber 30 or 31. An electric control unit (not shown) controls the fluid pressure in the first chamber 30 and the second chamber 31 of the main steering cylinder 26, via control valve devices associated with the chambers.

The third chamber 32 of the main steering cylinder 26 is also connected into a fluid circuit, in such a manner that the fluid flow into and out of the third chamber 32 is controlled by a control valve device 46, in this case, made as a 3/3 magnetic control valve. The 3/3 magnetic control valve 46 is actuated by an electric control device 48 which, depending on the wheel steering angle of the wheels 16 and 17 and by interaction with the electric control unit, either fills the third chamber 32 of the main steering cylinder 26 with fluid or drains fluid out of it. The electric control device 48 obtains information about the steering angle of the wheels 16 and 17 from sensors 44A, 44B, which determine the wheel steering angles by measuring the angle between the respective wheel hubs 41A and 41B and the transverse direction of the vehicle and which are in active connection with the electric control device 48.

In a vehicle of alternative design, a person with knowledge of the subject can also arrange sensors directly on the main steering cylinders, these sensors measure the position of the first piston element and the second piston element within the main steering cylinder. From the position of the piston elements, the electric control device can calculate the position of the wheels.

Likewise, a person with knowledge of the field can arrange for the function of the electric control device to be integrated in the electric control unit and, in that case, the electric control unit is in active connection with the wheel position determining sensors and the same electric control unit actuates the control valve device associated with the fluid chamber.

When the fluid chamber 32 of the main steering cylinder 26 of the first vehicle axle 10 is filled, the piston elements 34 and 35 in the main steering cylinder 26, connected to the piston rods 28, move away from one another in a direction parallel to the vehicle axle 10, such that the track rods 38A, 38B are also moved apart by the track rod links 39A, 39B. The wheel supports 40A and 40B and the wheel hubs 41A and 41B in a fixed angular relation with one another relative to the track rod links 39A, 39B are, therefore, rotated about the track rod links 39A and 39B by the movement of the track rods 38A, 38B. When the third chambers 32 of the two vehicle axles are drained, the wheels 16, 17, 18, 19 are swiveled away from their current positions about the steering rotation axes 42A, 42B in an analogous manner.

Accordingly, in an advantageous way, during normal forward or reverse driving, the wheel steering angles can be influenced by the electric control device 48 as a function of the positions of the wheels 16, 17 calculated from the data provided by the angle sensors 44A, 44B in such a manner that the extensions of the wheel hubs 41A, 41B meet at any time, while the vehicle is rounding a curve at a common point located outside the vehicle 1. This ensures that the vehicle 1 is operated with exceptionally low wear in the area of the wheels 16, 17, since, in that case, no stressful lateral sliding movements occur in the area of the wheels 16, 17.

Of course, it can also be that only one vehicle axle is fitted with a main steering cylinder having three chambers, particularly when only one steered vehicle axle is used. Furthermore, depending on the driving situation, low-wear operation can also be achieved by providing that only one of the two main steering cylinders of the vehicle axles is actuated by the electric control device, for example when the other, also steerable axle does not undergo any steering movement in the driving situation.

If the third chambers 32 of the main steering cylinders 26 are filled with fluid in such a manner that the extension of the center lines of the wheel hubs 41A, 41B of the wheels meet at a point in the middle of the vehicle as shown, the vehicle can be spun about the point in the middle of the vehicle by reversing the rotation direction of the wheels 16 and 18, and 17 and 19, respectively. By way of the electric control device, such a condition called for by a driver's wish can only be realized when the vehicle is at rest.

In the vehicle 1, represented in FIG. 1, the rotation direction reversal of the wheels 16 and 18, relative to the wheels 17 and 19, is carried out in the first differential unit 13 and the second differential unit 14, where the wheels 16, 17 or 18, 19 of a vehicle axle 10 or 11, respectively, are driven in different directions.

In a vehicle of alternative design, the wheel rotational direction on one side of the vehicle is reversed with the help of two planetary gearsets, one planetary gearset being arranged on one side of a vehicle axle in each case, between the differential unit and one of the wheels.

In the vehicle 1, represented in FIG. 2, the rotation direction of the wheels 16 and 18, relative to the wheels 17 and 19, is reversed in the distributor gear system 5 in particular by way of a planetary gearset and, in this case, too, the rotation direction of either the first drive shaft 21 and the third drive shaft 23 or the rotation direction of the second drive shaft 22 and the fourth drive shaft 24 is reversed when compared with normal driving.

### REFERENCE NUMERALS

1 vehicle
3 drive engine
4 transmission gearbox
5 distributor gear system
7 first drive shaft
8 second drive shaft
10 first vehicle axle
13 first differential unit
16 wheel
17 wheel
18 wheel
19 wheel
21 first drive shaft
22 second drive shaft
23 third drive shaft
24 fourth drive shaft
26 main steering cylinder
27 steering mechanism
28 piston rod
28A first section of the piston rod
28B second section of the piston rod
30 first chamber of the main steering cylinder
31 second chamber of the main steering cylinder
32 third chamber of the main steering cylinder
34 first piston element
35 second piston element
37A piston rod link
37B piston rod link
38A track rod
38B track rod
39A track rod link
39B track rod link
40A wheel support
40B wheel support
41A wheel hub
41B wheel hub
42A angle sensor
42B angle sensor
46 control valve device
48 electric control device
50 pressure line
51 pressure line

1-9. (canceled)

10. An all-wheel drive vehicle having a first steered vehicle axle (10) and a second steered vehicle axle (11), each of the first and the second steered axles (10, 11) comprising:
a main steering cylinder (26) with piston rods (28) in active connection with wheels (16, 17, 18, 19) of the vehicle axle (10, 11), each main steering cylinder (26) comprising a first chamber (30) and a second chamber (31) which are delimited by a piston element (34, 35) arranged to move longitudinally in a cylinder device and connected to one of the piston rods (28), and which is acted upon by a control pressure that is adjusted by an electric control unit to produce specified wheel steering angles,
wherein the main steering cylinder (26) further has a third chamber (32), located between the piston element (34, 35) of the main steering cylinder (26), the piston elements (34, 35), delimiting the first chamber (30) and the second chamber (31), is subject to a control pressure, the piston rods (28) comprise more than one section such that a first section (28A) is connected to a first piston element (34) that delimits the first chamber (30) and a second section (28B) is connected to a second piston element (35) that delimits the second chamber (31).

11. The all-wheel drive vehicle according to claim 10, wherein the third chamber (32) of each main steering cylinder (26) is acted upon by the control pressure via a respective 3/3 magnetic control valve.

12. The all-wheel drive vehicle according to claim 10, wherein at least one sensor (44A, 44B), for determining the steering angles of the wheels (16, 17, 18, 19), is connected to an electric control device (48) for adjusting the control pressure in the third chamber (32) of each main steering cylinder (28).

13. The all-wheel drive vehicle according to claim 12, wherein the electric control device (48) is connected to the electric control unit for adjusting the control pressures in the first chamber (30) and in the second chamber (31).

14. The all-wheel drive vehicle according to claim 10, wherein at least one sensor (44A, 44B) determines the steering angles of the wheels (16, 17, 18, 19), and the at least one sensor is connect with the electric control device (48).

15. The all-wheel drive vehicle according to claim 12, wherein at least one sensor (44A, 44B) is associated with one of the wheels (16, 17, 18, 19) and the piston element (34, 35) of one of the main steering cylinders (26).

16. The all-wheel drive vehicle according to claim 12, wherein a control valve device (46) is actuated by one of the electric control unit or the electric control device (48).

17. The all-wheel drive vehicle according to claim 10, wherein both of the first section (28A) of the piston rod (28) and the second section (28B) of the piston rod (28) comprise first and second parts, and the first and second parts (28A, 38A and 28B, 38B respectively) of the first section (28A) and of the second section (28B) are, in each case, connected to one another by a hinge joint (37A and 37B, respectively).

18. The all-wheel drive vehicle according to claim 10, wherein wheels (16, 18 or 17, 19) on one side of the vehicle are drivable in an opposite direction to wheels (17, 19 or 16, 18) on an opposite side of the vehicle.

19. An all-wheel drive vehicle, with a steered vehicle axle (10), the steered vehicle axle comprising:
a main steering cylinder (26) containing a first slidable piston (34) and a second slidable piston (35), an interior of the main steering cylinder (26) being delineated into a first chamber (30), a second chamber (31) and a third chamber (32), the first piston (34) separates the first chamber (30) and the third chamber (32), the second piston separates the second chamber (31) and the third chamber (32), the first chamber (30) is pressurized by a first control pressure, the second chamber (31) is pressurized by a second control pressure and the third chamber (32) is pressurized by a third control pressure;
a first piston rod section (28A) communicates with a first wheel (16) and, at one end, is fixed to the first piston (34);
a second piston rod section (28B) communicates with a second wheel (17) and, at one end, is fixed to the second piston (35); and
an electric control unit controls the first control pressure in the first chamber (30) for longitudinally biasing the first piston (34) such that the first piston rod section (28A) biases the first wheel (16) to adjust a steering angle of the first wheel (16) and the electric control unit controls the second control pressure in the second chamber (31) for longitudinally biasing the second piston (35) such that the second piston rod section (28B) biases the second wheel (17) to adjust a steering angle of the second wheel (17).

20. The all-wheel drive vehicle, with the steered vehicle axle (10) according to claim 19, wherein the third chamber (32) of each main steering cylinder (26) is pressurized by a third control pressure, via a respective 3/3 magnetic control valve.

21. The all-wheel drive vehicle, with the steered vehicle axle (10) according to claim 19, wherein a first sensor (44A) detects the steering angle of the first wheel (16) and a second sensor (44B) detects the steering angle of the second wheel (17), the first sensor (44A) and the second sensor (44B) each communicate the respective steering angles of the first wheel (16) and the second wheel (17) to the electronic control unit such that the electronic control unit controls the control pressure in the third chamber (32) of the main steering cylinder (28).

22. The all-wheel drive vehicle according to claim 21, wherein the first sensor (44A) communicates with one of the first wheel (16) and the first piston element (34) to sense the steering angle of the first wheel (16), and the second sensor (44B) communicates with one of the second wheel (17) and the second piston element (35) to sense the steering angle of the second wheel (17).

23. The all-wheel drive vehicle, with the steered vehicle axle (10) according to claim 21, wherein the electric control unit controls the control pressure in the third chamber (32) via a control valve (46).

24. The all-wheel drive vehicle, with the steered vehicle axle (10) according to claim 19, wherein the first piston rod section (28A) is coupled, via a first hinge joint (37A), to an independent third piston rod section (38A) which communicates with the first wheel (16), and the second piston rod section (28B) is coupled, via a second hinge joint (37B), to an independent fourth piston rod section (38B) which communicates with the second wheel (17).

25. The all-wheel drive vehicle according to claim 19, wherein the first wheel (16) and the second wheel (17) are rotatable in opposite direction.
